(19) United States
(12) Patent Application Publication
(10) Pub. No.: US 2011/0278830 A1
(43) Pub. Date: Nov. 17, 2011

(54) Method for producing an insert leaf for a book-like document

(75) Inventors: ANTON BRUNNER, Bad Kotzting (DE); THOMAS FLOCK, Schorndorf (DE); MATHIAS WEBER, Bodenwohr (DE)

(73) Assignee: Muhlbauer AG, Roding (DE)

(21) Appl. No.: 13/050,466

(22) Filed: Mar. 17, 2011

(30) Foreign Application Priority Data
Mar. 18, 2010 (DE) 10 2010 011 843.5

(51) Int. Cl. B42D 1/00; B42C 9/00

(52) U.S. Cl. 281/15.1; 412/1

(57) ABSTRACT

The invention relates to a method for producing an insert leaf for a book-like document, in particular to a method for producing a data page for an identification document. In order to achieve a straightforward method for producing an insert leaf (11), it is proposed for at least one hinge film (17, 18) to be provided, right from the start, as a constituent part of an insert-leaf blank (19) and for that part (22) of the insert-leaf body which is not required to be separated off, in order to produce the hinge region (12).

The invention relates to a method for producing an insert leaf for a book-like document, in particular to a method for producing a data page for an identification document.

Identification documents are understood hereinbelow to mean, for example, passports, book-like forms of personal ID, drivers licenses, provisional personal documents, security documents, access authorization or the like.

Book-like identification documents generally comprise a plastics-material or cardboard or linen jacket and data pages made of paper and/or plastics material, in particular polymer material (PVC, polycarbonate, etc.). The data pages are fastened on the jacket, or on the inside cover page, usually with the aid of a seam. The data page here is also referred to as the holder page.

In particular data pages made of plastics material have inadequate bending properties, and this therefore necessitates the provision of a hinge region, which is connected to the main body of the insert leaf and projects beyond the periphery of the main body. The insert leaf is connected to at least one further part of the book-like document, in particular the book jacket or the book cover, in the hinge region with the aid of the seam connection.

The hinge region is distinguished from the main body of the insert leaf in that it has better bending properties. This is usually achieved in that the hinge region of the insert leaf is considerably less thick than the main body of the insert leaf.

In the case of the prior-art methods, an insert leaf provided with a hinge region is produced such that, in the first instance, the various films which form the insert leaf are connected to one another. If a polymer data page is required, then a number of core films and overlay films are laminated. The main bodies of the subsequent insert leaves are cut, preferably punched, out of the resulting sheet. In a following, second laminating step, a hinge film is laminated onto the main body. In the concluding, second severing step, the laminated-on hinge film is cut to size to give the finished insert leaf. The disadvantage with this conventional method is that it comprises a total of two laminating steps and two punching steps.

It is therefore an object of the present invention to provide a less laborious method for producing an insert leaf.

This object is achieved by a method according to claim 1. Advantageous embodiments of the invention are given in the dependent claims.

The configurations and advantages explained in the following text in conjunction with the method also apply analogously to the insert leaf according to the invention and vice versa.

A core idea of the invention is that of providing at least one hinge film, right from the start, as a constituent part of an insert-leaf blank and of separating off that part of the insert-leaf body which is not required, in order to produce the hinge region.

More precisely, the idea of the invention is for the at least one hinge film, which should subsequently form the hinge region of the insert leaf, not to be fastened on the main body of the insert leaf in an additional step; rather, this at least one hinge film should be provided, right from the start, as a constituent part of the insert leaf. For this purpose, the at least one hinge film is used, together with the other films which form the main body of the insert leaf, to produce the insert-leaf sheet in a preferably single production step, a plurality of insert-leaf blanks then being cut out of the insert-leaf sheet. The insert-leaf blanks are already of the subsequent final size of the finished insert leaves. The insert-leaf blanks do not yet have a hinge region. The hinge region is produced in a third, concluding step by part of the insert-leaf body, that is to say that part which is above the subsequent hinge region, and directly adjacent to the subsequent main body, being separated off from the insert-leaf blank. In other words, with the exception of the at least one hinge film, all the other films are removed from the region of the subsequent hinge region.

Production is vastly simplified by this method. The production times are shortened. The production costs are reduced.

If the act of connecting the films to form the insert-leaf sheet takes place in a single operation, then a second laminating step can be dispensed with altogether. This also does away with the waiting time which is necessary after each laminating operation.

The act of separating off the part of the insert-leaf body for the purpose of creating the hinge region can take place in a single operation, preferably such that the part which is to be separated off is separated off from the at least one hinge film to the full extent with the aid of machining. If the machining is done by milling, severing can take place particularly straightforwardly and cost-effectively. In addition to machining, however, it is also possible to use other severing methods. For example, the part which is to be separated off can also be removed thermally, chemically or electrochemically, in particular by etching.

As an alternative to this, it is possible for that part of the insert-leaf body which is not required to be separated off with the aid of a separating film which, during production of the insert-leaf sheet, was arranged between the at least one hinge film and the rest of the films of the insert leaf. The separating film is then drawn off from the at least one hinge film together with that part of the insert-leaf body which is to be separated off. Particularly suitable separating films here are made of such materials as adhere only to a slight extent, if at all, to the surface of the at least one hinge film, it therefore being possible for the separating film to be drawn off easily with that part of the insert-leaf body which is to be separated off.

During production of the insert-leaf sheet, the separating film is advantageously arranged only in the region of the subsequent hinge, region, and therefore it does not subsequently start coming away from parts of the main body in an undesired manner.

In order to make it easier for the separating film to be drawn off, and to ensure defined separation of the main body and hinge region, it is advantageous if, prior to the separating film being drawn off, a continuous separating groove which runs in the longitudinal direction of the hinge and determines the course taken by the hinge region is introduced into that part of the insert-leaf body which is to be separated off. The separating groove need not be very wide, since it is intended to create merely a separation between the main body, on the one hand, and the part which is to be separated off, on the other hand. The groove can be, for example, milled into the part which is to be separated off. However, it is likewise possible for the groove to be configured as a cut, without any significant amount of material being removed. The separating groove here is wide enough to sever the separating film, but the at least one hinge film remains intact.

The separating film is drawn off preferably such that that part of the insert-leaf body which is to be separated off, and is arranged on the separating film, is gripped and is drawn off from the at least one hinge film together with the separating film. For this purpose, a suitable drive means is used to subject the part which is to be separated off to a sufficient pulling force. The material of the separating film here is such that the separating film, rather than becoming detached, during the drawing-off action, from the part which is to be separated off, can be drawn off from the at least one hinge film together with this part.

It is particularly advantageous if the act of separating off that part of the insert-leaf body which is not required gives rise to a portion of the hinge region which is adjacent to the main body being formed as a transition region such that removal of the at least one hinge film from the insert leaf either is not possible or inevitably gives rise to the insert leaf being damaged or destroyed. This can reliably avoid the situation where the insert leaf is changed in an undesired manner. The side edge of the main body preferably runs into the hinge region obliquely in relation to the surface of the at least one hinge film.

The invention relates predominantly to data pages made of plastics materials (PC, PVC, PETG, etc.), since the problem of lack of bending properties is present to a pronounced extent in these materials.

Exemplary embodiments of the invention will be explained in more detail hereinbelow with reference to the drawings, in which:

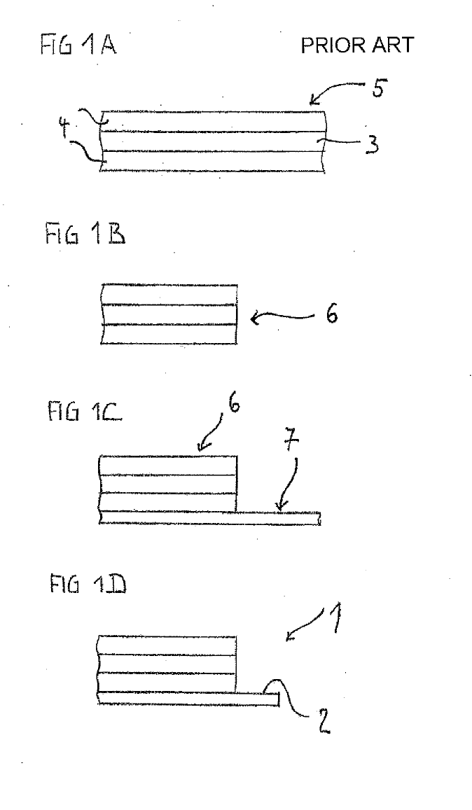

FIG. 1 shows the sequence of a production method according to the prior art,

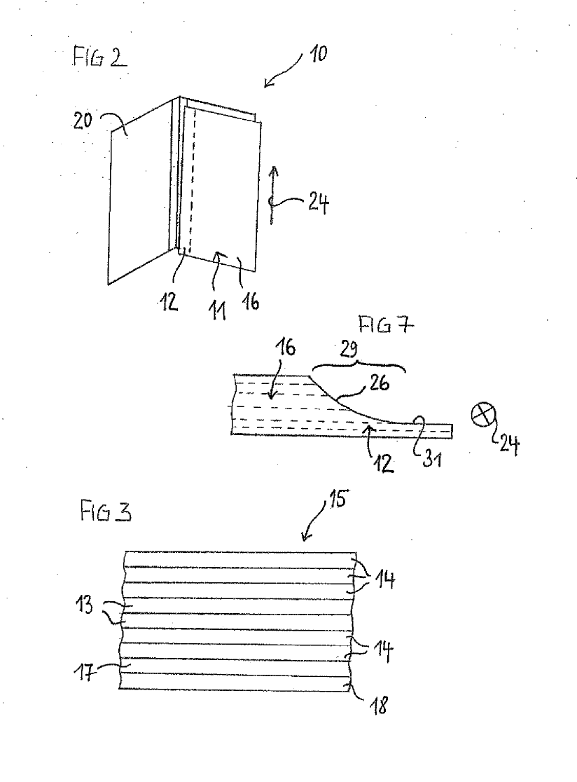

FIG. 2 shows a perspective illustration of an identification document having a holder page,

FIG. 3 shows a vertical section through an insert-leaf blank cut out of an insert-leaf sheet,

FIG. 4 shows a vertical section through a first embodiment of a holder page according to the invention in the transition region between the hinge region and main body,

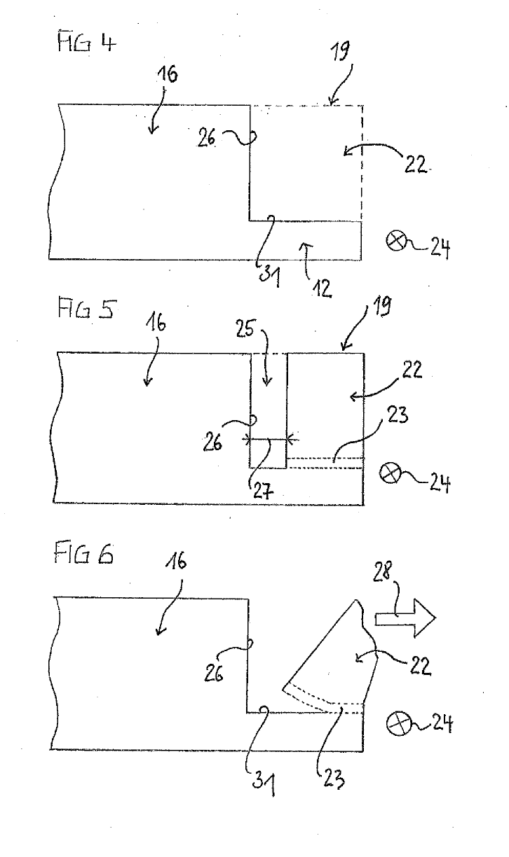

FIG. 5 shows a vertical section through a second embodiment of a holder page according to the invention in the transition region between the hinge region and main body,

FIG. 6 shows a vertical section through a second exemplary embodiment of a holder page according to the invention as the separating film is being drawn off, and

FIG. 7 shows a vertical section through a holder page in the transition region with a rounded milled edge.

All the figures show the invention merely schematically and by way of its essential constituent parts. The same reference signs here depict elements with the same or comparable function.

FIG. 1 will be used to describe a prior-art method for producing an insert leaf 1 which is provided with a hinge region 2 on one longitudinal side.

In the first instance, the various films which form the insert leaf 1 are connected to one another with the aid of lamination. A core film 3 and also an upper and a lower overlay film 4 are illustrated symbolically here. The resulting insert-leaf sheet 5 has a main body 6 of the subsequent insert leaf 1 punched out of it with the aid of a punching machine. This main body 6 has no hinge region 2 as yet. In a following, second laminating step, a hinge film 7 is laminated onto the main body 6 with the aid of a laminating machine. In the concluding step, the hinge film 7 is cut to size with the aid of a punching machine to give the finished insert leaf 1.

FIG. 2 depicts a book-like identification document 10 having an insert leaf 11 in the form of a polymer data page (holder page) 11. The insert leaf 11 has a main body 16 and a hinge region 12, which is connected to the main body 16. In the hinge region 12, the insert leaf 11 can be connected to the book cover 20 by means of a seam connection (not illustrated).

The sheet 15, from which the insert leaves 11 are punched out, is made up essentially of polymer materials. In the present case, as illustrated in FIG. 3, a core film 13 may of polycarbonate (PC) has three PC overlay films 14 provided above it, while two further PC overlay films 14 are provided beneath a second PC core film 13, which is adjacent to the first core film 13.

The lower overlay film 14 is followed by two laminating films. The film which is connected directly to the lowermost overlay film 14 is a laminating film 17 made of thermoplastic polyurethane (TPU), which ensures the desired flexibility of the hinge region 12. The second hinge film is a further PC overlay film 18, which covers the TPU film 17. All the films 13, 14, 17, 18 are connected to one another in a single production step.

Once the sheet 15 has been produced, a plurality of insert-leaf blanks 19 are cut out of the same.

Finally, the hinge region 12 is produced, by part 22 of the insert-leaf body, that is to say that part which is above the subsequent hinge region 12, and is directly adjacent to the subsequent main body 16, being separated off from the insert-leaf blank 19.

For this purpose, in one embodiment of the invention, as illustrated in FIG. 4, that part 22 of the insert-leaf body which is to be separated off is removed in a single operation, by the films 13, 14 which are not required in the hinge region 12 being machined off using a milling machine. The hinge region 12 is then considerably less thick than the main body 16. For example, the thickness of the main body 16 is approximately 0.8 millimeters, whereas the thickness of the hinge region 12 is only 0.1 to 0.2 millimeters.

In a further embodiment of the invention, a separating film 23, as is illustrated in FIG. 5, is introduced during production of the insert-leaf sheet 15, in the region of the hinge region 12, between the TPU film 17 and the overlay film 14. The separating film 23 is not depicted in FIG. 3.

For the purpose of separating off that part 22 of the insert-leaf body which is not required, a continuous separating groove 25 which runs in the longitudinal direction 24 of the hinge and determines the course taken by the hinge region 12 is introduced into that part of the insert-leaf body which is to be separated off. The hinge films 17, 18 are not damaged as a result of the separating groove 25 being introduced. In the example illustrated in FIG. 5, the separating groove 25 is configured as a milled groove. The separating groove 25 has already severed the separating film 23 there. Prior to the separating groove 25 being introduced into the body of the insert-leaf blank 19, the separating film 23 ran as far as the outer side edge 26 of the main body 21, this side edge forming the periphery 30 of the main body 21. If the separating groove 25 is always of a minimum width 27 which is known beforehand, it is possible for the separating film 23, rather than having to run right up to the side edge 26 of the main body 21, to be narrow enough to terminate at the separating groove 25.

The separating film 23 is then drawn off from the TPU film 17 together with that part 22 of the insert-leaf body which is to be separated off, see FIG. 6. For this purpose, use is made of a drive means (not illustrated specifically), with the aid of which the part which is to be separated off is subjected to a sufficient pulling force, which is symbolized by arrow 28 in FIG. 6.

The separating film 23 is a plastics material, the use of which ensures, on the one hand, that the separating film 23 adheres only slightly, if at all, to the surface 31 of the TPU film 17 and, on the other hand, that the separating film 23 does not become detached, during the drawing-off action, from the part 22 which is to be separated off. The material used for the separating film is preferably polyethylene (PE), polyethylene terephthalate (PET) or the like.

FIG. 7 illustrates an exemplary embodiment of the invention in which a portion of the hinge region 12 which is adjacent to the main body 21 is formed as a transition region 29 such that removal of the hinge films 17, 18 from the insert leaf 11 inevitably gives rise to the insert leaf 11 being damaged. For this purpose, the side edge 26 of the main body, in the transition region 29, runs into the hinge region 12 obliquely in relation to the surface 31 of the TPU film 17. This is achieved in that milling of the separating groove 25 creates a rounded milled edge, which forms the side edge 26 of the main body 21. The radius of the milled edge here is preferably 1 to 2 mm. The rounded milled edge makes it possible to avoid a sharp-edged transition. The various constituent parts of the holder page are more difficult to separate from one another again. The composite arrangements can be broken up only by the holder page being destroyed.

All the features illustrated in the description, the following claims and the drawing may be essential to the invention both individually and in any desired combination.

### LIST OF REFERENCE SIGNS

1 Insert leaf
2 Hinge region
3 Core film
4 Overlay film
5 Insert-leaf sheet
6 Main body
7 Hinge film
8 (free)
9 (free)
10 Identification document
11 Insert leaf, holder page
12 Hinge region
13 Core film
14 Overlay film
15 Insert-leaf sheet
16 Main body
17 TPU film
18 Overlay film
19 Insert-leaf blank
20 Book cover
21 Main body
22 That part of the blank which is not required
23 Separating film
24 Longitudinal direction of the hinge
25 Separating groove
26 Main-body edge, periphery
27 Groove width
28 Pulling direction
29 Transition region
30 Periphery
31 Surface

What is claimed is:

1.-10. (canceled)

11. A method for producing an insert leaf for a book-like document, the insert leaf having a main body and a hinge region, said method comprising the steps of:
connecting a number of films to form an insert leaf sheet; wherein the films comprise at least one hinge film;
separating an insert leaf blank from the insert leaf sheet to form a main body of the insert leaf;
removing a portion of the insert leaf main body for creating a hinge region at the main body such that the hinge region projects beyond a periphery of the main body; wherein the hinge region comprises the at least one hinge film.

12. The method according to claim 11, wherein connecting the films to form the insert-leaf sheet takes place in a single operation.

13. The method according to claim 11, wherein separating the portion of the insert leaf main body takes place in a single operation.

14. The method according to claim 13, wherein the single operation is carried out by a machining step.

15. The method according to claim 11, further comprising that during the step of connecting the films to form the insert leaf sheet, a separating film is arranged between the at least one hinge film and the rest of films in the region of the insert leaf sheet that subsequently serves as the hinge region, wherein the separating film, during the separating step, is drawn off from the at least one hinge film together with the portion which is to be separated off.

16. The method according to claim 15, wherein the act of drawing off the separating film is carried out by subjecting the portion to be separated to a pulling force.

17. The method according to claim 15, wherein, prior to drawing off the separating film, a separating groove is introduced into the portion to be separated off, said groove determining the course of the hinge region.

18. The method according to claim 11, wherein, during the step of removing the portion of the insert-leaf body, a portion of the hinge region adjacent to the main body is formed as a transition region, said transition region preventing removal of the at least one hinge film from the insert leaf without damaging the insert leaf.

19. The method according to claim 18, wherein a side edge of the main body extends into the hinge region obliquely in relation to a surface of the at least one hinge film.

20. An insert leaf produced by a method comprising the steps of:
connecting a number of films to form an insert leaf sheet; wherein the films comprise at least one hinge film;
separating an insert leaf blank from the insert leaf sheet to form a main body of the insert leaf;
removing a portion of the Insert leaf main body for creating a hinge region at the main body such that the hinge region projects beyond a periphery of the main body; wherein the hinge region comprises the at least one hinge film.

21. A book-like document, in particular identification document, comprising at least one insert leaf produced by the steps of:
connecting a number of films to form an insert leaf sheet; wherein the films comprise at least one hinge film;
separating an insert leaf blank from the insert leaf sheet to form a main body of the insert leaf;
removing a portion of the insert leaf main body for creating a hinge region at the main body such that the hinge region projects beyond a periphery of the main body; wherein the hinge region comprises the at least one hinge film.
